(19) United States
(12) Patent Application Publication
(10) Pub. No.: US 2007/0095973 A1
(43) Pub. Date: May 3, 2007

(54) Aircraft having a helicopter rotor and an inclined front mounted propeller

(76) Inventor: Douglas Challis, Cartier (CA)

Correspondence Address: ADE & COMPANY INC., 2157 Henderson Highway, WINNIPEG, MB, R2G1P9, CA

(21) Appl. No.: 11/259,353

(22) Filed: Oct. 27, 2005

(51) Int. Cl. B64C 27/08

(52) U.S. Cl. 244/17.21

(57) ABSTRACT

An aircraft features a nose mounted propeller on a fuselage having a typical helicopter rotor assembly. The propeller axis of rotation is tilted upward from the longitudinal axis of the fuselage so that its rear face points downward. By reducing the amount of lift and forward thrust needed from the main rotor, the propeller allows greater forward speeds as the angle of attack on the rotor's blades can be kept low to avoid the stalling and violent vibration experienced by conventional helicopters at relatively high speeds. By greatly reducing the amount of thrust produced by the main rotor but still using it to generate lift, the addition of wings can be avoided. The aircraft can be flown in a forward direction in a generally horizontal orientation, as the nose does not have to be pitched downward to create thrust from the main rotor.

The present invention relates to an aircraft and more particularly to an aircraft having a fuselage with a helicopter rotor supported on the top and a propeller mounted on the front for providing forward thrust.

### BACKGROUND

Conventional helicopters, while offering drastically improved manoeuvrability over airplanes, are limited to travelling at relatively low speeds. During vertical motion or hovering, the helicopter is oriented horizontally such that the main rotor is driven for rotation about a generally vertical axis to create lift. To achieve forward motion, the helicopter is tilted nose down out of the horizontal orientation by adjusting the cyclic pitch to increase the angle of attack of the rotor blades during a portion of their rotation in which they extend rearward from the hub, thereby create more lift near the rear of the aircraft. With the aircraft in this tilted position, the rotor acts to create both lift and forward thrust.

The effective air speed of a blade as it advances in its rotation is the sum of the forward speed of the helicopter and the blades rotational speed, as the motion of the blade relative to the helicopter is in a forward direction. The effective air speed of a retreating blade however, is the difference between the rotational speed and the forward speed of the helicopter, as they are in opposite directions. Since lift varies with the square of velocity, the advancing blade will thus produce more lift than the retreating blade. This dissymmetry of lift is at least partially corrected by blade flapping which increases and decreases the angles of attack of the retreating and advancing blades respectively to create more lift and balance the overall lift provided by the rotor. Increasing the angle of attack too much will cause a blade to stall, as smooth laminar airflow over the surfaces of the blade is lost. As the critical angle of attack is approached, the blades undergo violent vibrations known as buffeting. As a result, conventional helicopters are limited in their maximum speed as increasing the forward velocity leads to a need for increased angle of attack for retreating blades, and a high angle of attack will lead to stalling and a corresponding lack of lift.

Compound helicopters have been developed to try and overcome the speed limitations of conventional helicopters. These compound aircraft combine features of the helicopter with those of an airplane in an attempt to provide the manoeuvrability of the former and the speed of the latter. U.S. Pat. Nos. 2,531,976 and 2,575,886 by Garrett and Myers respectively and U.S. Patent Application Publication No. 2005/0151001 by Loper describe compound helicopters that have wings and nose mounted propellers that provide lift and thrust respectively for forward flight at speeds that could not be achieved using their main rotors. Garrett teaches a main rotor assembly that is folded down into a fuselage of the aircraft during forward flight. Myers teaches a main rotor that is stopped in a position parallel to the line of flight when approaching the stalling speed so as not to create drag during forward flight provided by the propeller and wings. Loper teaches a main rotor that is unloaded to autogyrate during cruising flight so that the majority of lift is provided by the wings. The presence of wings on these aircraft decrease the efficiency of using the main rotor to create lift during vertical movement, hovering and the transition from hovering to forward flight as their surface area creates vertical drag. Wings also increase the weight of the aircraft and the cost of its manufacture due to more material and assembly requirements.

As a result, there is a desire for a helicopter capable of higher forward cruising speeds than a conventional helicopter without requiring the addition of wings below the main rotor.

### SUMMARY

According to a first aspect of the present invention there is provided an aircraft comprising:

a fuselage having a front end, a rear end and a longitudinal axis;

a main helicopter rotor supported for rotation about an axis thereof on top of the fuselage, said rotor being operable to control both vertical and horizontal movement of the aircraft;

a propeller supported for rotation about an axis thereof at the front end of the fuselage for selectively producing thrust to move the aircraft forward; and

at least one powerplant supported on the fuselage;

the main rotor and propeller each being operatively connected to the at least one powerplant for selective driven rotation thereby;

wherein vertical lift of the aircraft is provided substantially wholly by the main helicopter rotor;

the propeller being supported for rotation in a plane transverse to the fuselage, said plane being inclined with respect to the longitudinal axis of the fuselage to extend upward from front to rear with said longitudinal axis horizontally oriented.

The present invention provides a nose mounted propeller on a fuselage having a typical helicopter rotor assembly that can be adjusted by the pilot to provide vertical lift and horizontal thrust in forward, rearward and transverse directions. The propeller axis is not parallel to the longitudinal axis of the fuselage, but rather is tilted so that a rear face of the propeller points downward when the aircraft is oriented horizontally. By reducing the dependency on the main rotor for forward thrust, the propeller allows greater forward speeds as the angle of attack on the rotor's blades can be kept low to avoid the stalling and violent vibration experienced by conventional helicopters at relatively high speeds. By greatly reducing the amount of forward thrust produced by the main rotor but still using it to generate lift, the addition of wings can be avoided.

The at least one powerplant may comprise a propeller powerplant and a rotor powerplant, the propeller and main helicopter rotor being operatively connected to the propeller and rotor powerplants respectively. Alternatively, the at least one powerplant may comprise a common powerplant having a rotor output and a propeller output, the propeller and main helicopter rotor being operatively connected to the propeller and rotor outputs respectively.

The propeller may be adjustable in pitch and/or pivotally mounted to allow adjustment of an angle at which the transverse plane in which said propeller rotates is inclined with respect to the longitudinal axis of the fuselage. In the case where the propeller is provided with its own powerplant, this angle may be adjusted by pivotally mounting the propeller and propeller powerplant together.

Preferably there is provided a torque countering device for countering a torque reaction exerted on the fuselage about the axis of the main helicopter rotor caused by driven rotation of said rotor. The torque countering device may comprise a tail rotor supported for rotation in generally vertical plane parallel to the longitudinal axis of the fuselage rearward of said fuselage.

There may be provided one or more stabilizers supported rearward of the fuselage.

### BRIEF DESCRIPTION OF THE DRAWINGS

In the accompanying drawings, which illustrate a exemplary embodiments of the present invention:

FIG. 1 is a side view of an aircraft according to a first embodiment of the invention having a main helicopter rotor and an inclined front mounted propeller driven by separate powerplants.

FIG. 2 is a top view of the aircraft of FIG. 1 with the main helicopter rotor, tail rotor and propeller being driven for rotation.

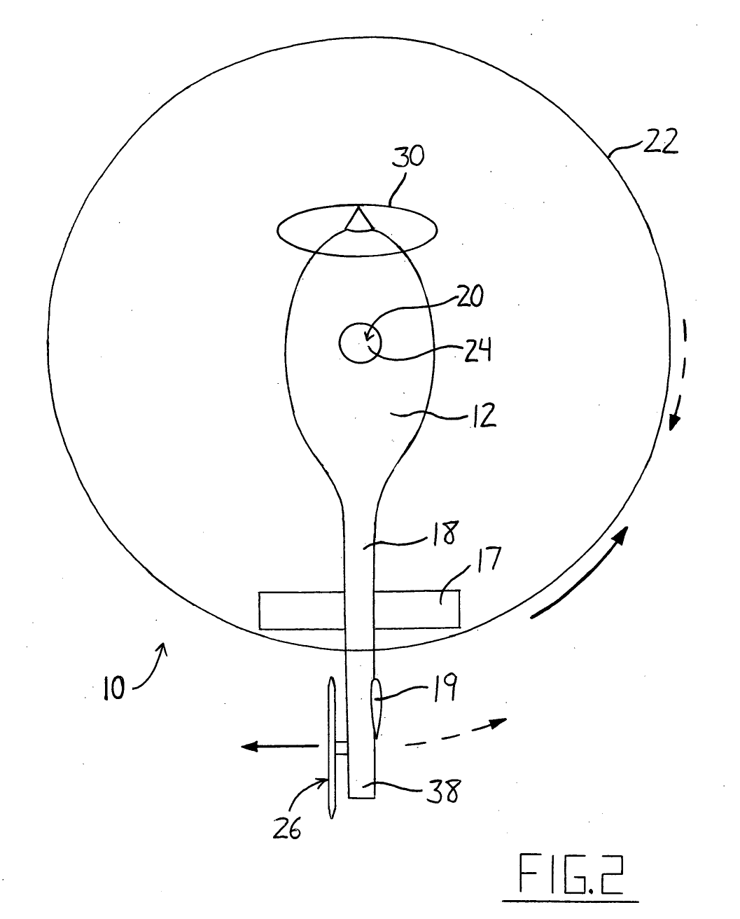

FIG. 3 is a side view of an aircraft according to a second embodiment of the invention having a main helicopter rotor and an inclined front mounted propeller driven by a common powerplant.

### DETAILED DESCRIPTION

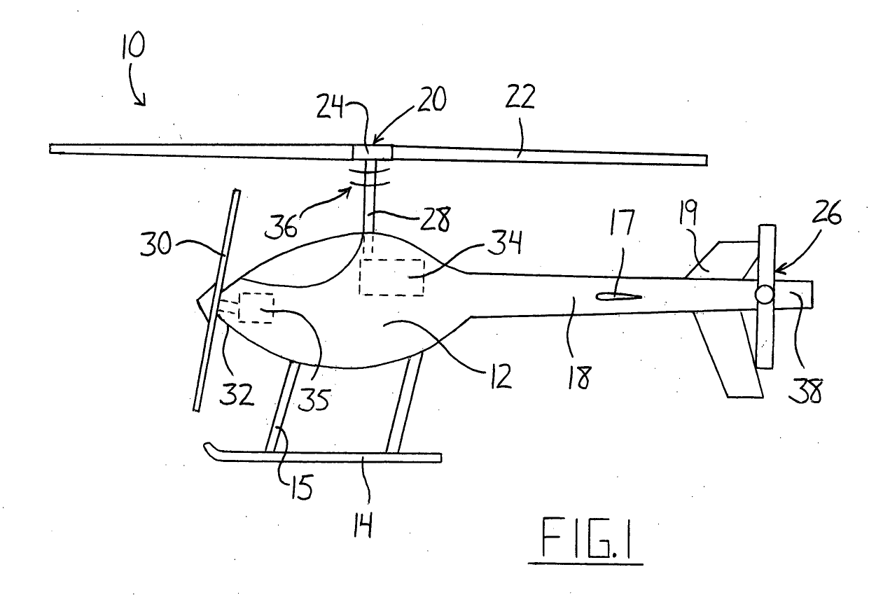

As shown in FIG. 1, the aircraft of the present invention has many features in common with the conventional helicopter. The aircraft 10 has a fuselage 12 supported atop a pair of skids 14 by braces 15 with a tail boom 18 extending rearward from the fuselage 12. Suitable landing gear other than skids are known to those of skill in the art may be substituted into the present invention. A main rotor assembly 20 consisting of blades 22 extending radially outward from a hub 24 is supported above the fuselage 12. A tail rotor 26 is supported near an end of the tail 18 opposite the fuselage 12. A horizontal stabilizer 17 and a vertical stabilizer 19 are supported on the tail boom 18 for stability during flight. These components are all similar in structure and function to those found on a conventional helicopter. The main rotor assembly 20 is controlled by a pilot to provide uniform lift for vertical movement or unbalanced lift to tip the aircraft and induce lateral movement. The tail rotor 26 is driven for rotation to provide transverse thrust to create a moment about the rotor's shaft 28 to oppose a tendancy for the fuselage to rotate about the shaft due to the driven rotation of the main rotor assembly 20.

The aircraft 10 of the present invention differs from the conventional helicopter in that there is provided a propeller 30 on the nose, or front end, 32 of the fuselage 12. The tractor propeller 30 is driven for rotation in order to produce forward thrust for the aircraft. While operated in the same manner as a conventional helicopter during vertical, sideways and rearward movement, the improvements of the present invention are most apparent during forward flight, in which operation of the propeller 30 reduces the reliance on the main rotor 20.

As in conventional helicopters, the rotor assembly is supported atop the shaft 28 that is operatively coupled to a powerplant 34 mounted within the fuselage for driven rotation. A typical swashplate assembly 36, known to those of skill in the art, provided on the shaft 28 allows cyclic and collective pitch control of the rotor blades 22. The collective pitch control allows the pilot to simultaneously change the pitch of all the blades 22 in order to increase or decrease the angle of attack of the blades to achieve the desired amount of thrust. The cyclic pitch control allows the pilot to change the pitch of the blades 22 depending on their position during rotation, thereby controlling the direction in which the thrust is applied. In conventional helicopters, creating a difference in the angle of attack from one side of the hub 24 to an opposite side by means of the cyclic pitch control creates uneven lift across the rotor assembly 20 which causes the aircraft 10 to tilt and move toward the lowered side having less lift. The same procedure is followed when operating the aircraft 10 of the present invention, except that when forward movement is desired, power can be provided to the propeller 30 to provide forward thrust. This reduces the need for forward thrust from the main rotor 20, so the aircraft 10 does not have to be tilted as far forward as a conventional helicopter to attain forward motion. It should be appreciated however, that from a hovering state, the aircraft 10 may be transitioned to forward cruising in the same manner as a conventional helicopter.

In a conventional helicopter the pitch of retreating blades needs to be increased over that of advancing blades by the cyclic control in order to provide forward thrust during forward cruising. When flying forward with the present invention, the angle of attack of the retreating blades does not have to be as high, due to the fact that the propeller is providing thrust for forward cruising. The required collective and cyclic pitches of the blades 22 are therefore less than those required for forward flight in a conventional helicopter, as less overall thrust is needed from the main rotor 20 and it can be adjusted to focus on creating lift. This decrease in the required angle of attack of the blades 22 leads to faster possible forward motion without reaching the critical angle of attack at which buffeting occurs and beyond which stalling may take place.

As in a conventional helicopter, the driven rotation of the main rotor 20 causes a reactive torque to be exerted on the fuselage 12 in a direction opposite that of the rotor's motion. The tail rotor 26 at the end 38 of the tail 18 is driven for rotation in order to create thrust transverse to the length of the aircraft 10. This thrust creates a moment which tends to rotate the fuselage 12 about the shaft 28 of the main rotor assembly 20 in a direction opposite the reaction torque created by the rotation thereof. The magnitude of the thrust and resulting moment can be controlled by adjusting the pitch of the tail rotor 26. The energy exerted to drive the tail rotor 26 is generally considered to be wasteful, as it does not contribute to the airspeed of the aircraft 10, but rather is only used to prevent relative motion of its components. The vertical stabilizers of conventional helicopters located on the tail near the tail rotor are sometimes angled with respect to a longitudinal axis of the aircraft. During forward flight, this angled arrangement creates a force transverse to the longitudinal axis which opposes the reaction torque of the main rotor. Moving forward at higher speeds, this transverse force may be strong enough to counteract all of this spin inducing torque. It should be appreciated that the vertical stabilizer 19 of the present invention may be supported in an angled orientation to reduce reliance on the tail rotor 26.

As seen in FIG. 1, the propeller 30 of the present invention is not mounted on the nose 32 so as extend in a vertical plane parallel to the main rotor shaft 28 and perpendicular to a longitudinal axis of the fuselage 12. The propeller 30 is tilted rearward such that a lowest point in its rotation is disposed forward of a highest point in its rotation. In other words, the axis of the propeller 30 has been rotated downward about a front end thereof from a longitudinal axis of the fuselage 12 in a vertical plane by a small angle. With the propeller used to generate thrust for forward motion, the cyclic pitch of the main rotor 20 does not have to be adjusted to provide more lift at the rear of the aircraft 10 in order to create forward thrust, and thus the aircraft does not have to be tilted forward to the same degree of conventional helicopters. The present invention thereby provides options to the pilot for transitioning to forward flight. The nose 32 can be pitched downward to tilt the aircraft 10, and thus the main rotor 20, forward to create forward thrust from the main rotor in the typical fashion. Alternatively, the power to the propeller 30 can be increased to provide forward thrust while maintaining a generally horizontal orientation of the aircraft 10.

Higher top speeds can be achieved due to the lower angle of attack of the rotor blades 22 which helps avoid the stalling and vibration problems that limit the forward velocity of conventional helicopters. The slipstream from the propeller 30 travels downward as it moves toward the tail 18, thereby moving away from both the main rotor 20 and the fuselage 12. This reduces interference of the downwash from the main rotor 20 and the slipstream from the propeller 30, thereby reducing instability caused by disruption of either airflow in close proximity to the rotor.

It should be appreciated that the main rotor 20, as viewed from above, could alternatively be rotated in a clockwise direction. In this case the reaction torque exerted on the fuselage would act in a counter-clockwise direction about the main rotor shaft 28. In such a case, the tail rotor 26 would be disposed on a side of the tail 18 opposite that shown in the figures in order to properly counteract the reaction torque of the main rotor.

FIG. 1 schematically shows that the first embodiment of the present invention features a rotor powerplant 34 and a propeller powerplant 35 for separately providing power to drive the rotor 20 and propeller 30 respectively. A radio controlled prototype of the first embodiment of the present invention has been able to achieve forward speeds of approximately twice what was attainable without the nose mounted propeller. Test flights in which the propeller was not tilted back as described herein above showed a tendency for the aircraft to drastically pitch forward when power to the propeller was increased out of an idling state. The prototype has been found to fly well with a propeller of relatively fine pitch tilted back approximately twelve degrees from a vertical orientation and a rotor motor having a power rating double that of a propeller motor. It should be appreciated that the aforementioned details of this prototype have been presented in an exemplary context and that the present invention is not limited to this particular propeller and powerplant arrangement.

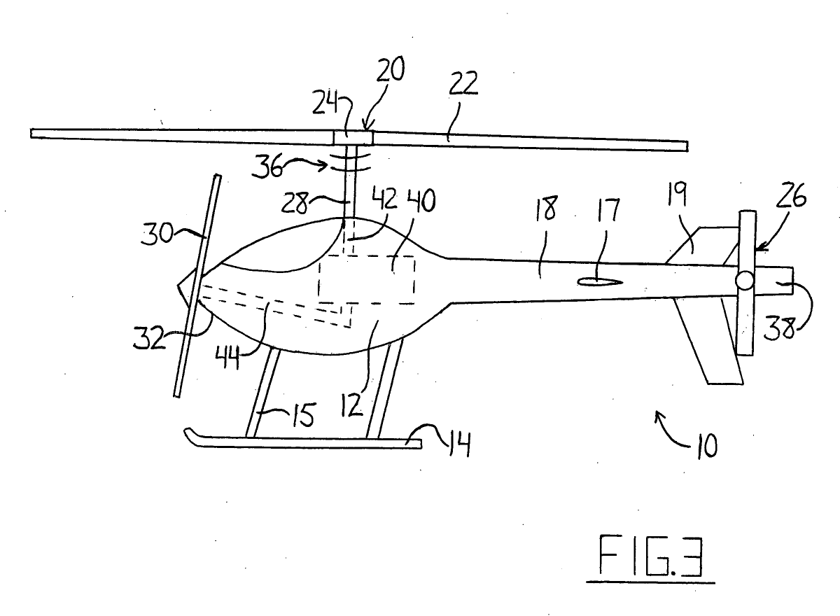

FIG. 3 schematically shows the drive system of a second embodiment of the present invention. A single common powerplant 40 has separate rotor and propeller outputs 42 and 44 that are operatively connected to the main helicopter rotor and propeller respectively. In the illustrated embodiments, the tail rotor is adjustable in pitch and driven off the main rotor in an arrangement typically found in conventional helicopters. It should be appreciated that the present invention can be adapted to be powered by various systems known to those of skill in the art.

Tests have shown that a combination of factors, such as the propeller pitch, propeller size, propeller tilt angle, propeller speed and forward air speed, seem to affect the relationship between the longitudinal axis of the fuselage and the line of forward thrust exerted on the aircraft 10. It should therefore be appreciated that by providing control over as least some of these factors, the orientation or trim of the aircraft can be better controlled during forward flight, for example to maintain a parallel relationship between the forward thrust line and the longitudinal axis of the fuselage to allow forward flight in a horizontal orientation. The propeller 30 may be of the variable pitch type to allow control of its pitch during flight. The propeller 30 may be pivotally mounted for limited motion about an axis transverse to the fuselage to allow control over the angle between the propeller's plane of rotation and the longitudinal axis of the fuselage. This would provide the ability to fine tune the tilt of the propeller 30 order to maintain a horizontal orientation of the aircraft 10 during forward flight at particular speeds. The pivotal mounting may be made controllable by the pilot to allow small adjustments during flight, or could be made to be adjustable only during grounded maintenance. The latter option would allow adjustments in the angle of tilt to be made to compensate for exchangeable mounting of propellers having different sizes or pitches without having to add another control device for the pilot in the aircraft. In the first embodiment where the propeller 30 is provided with its own propeller power plant 35, the two components may be supported on a single pivotal mount to provide this tilt control.

The present invention outlines an aircraft 10 that provides the manoeuvrability of a conventional helicopter with an increased attainable forward air speed, without the addition of wings which can interfere with the lift providing capabilities of the main rotor.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An aircraft comprising:
a fuselage having a front end, a rear end and a longitudinal axis;
a main helicopter rotor supported for rotation about an axis thereof on top of the fuselage, said rotor being operable to control both vertical and horizontal movement of the aircraft;
a propeller supported for rotation about an axis thereof at the front end of the fuselage for selectively producing thrust to move the aircraft forward; and
at least one powerplant supported on the fuselage;
the main rotor and propeller each being operatively connected to the at least one powerplant for selective driven rotation thereby;
wherein vertical lift of the aircraft is provided substantially wholly by the main helicopter rotor;
the propeller being supported for rotation in a plane transverse to the fuselage, said plane being inclined with respect to the longitudinal axis of the fuselage so as to extend upward from front to rear with said longitudinal axis horizontally oriented.

2. The aircraft according to claim 1 wherein the at least one powerplant comprises a propeller powerplant and a rotor powerplant, the propeller and main helicopter rotor being operatively connected to the propeller and rotor powerplants respectively.

3. The aircraft according to claim 1 wherein the at least one powerplant comprises a common powerplant having a rotor output and a propeller output, the propeller and main helicopter rotor being operatively connected to the propeller and rotor outputs respectively.

4. The aircraft according to claim 1 wherein the propeller is adjustable in pitch.

5. The aircraft according to claim 1 wherein the propeller is pivotally mounted to allow adjustment of an angle at which the transverse plane in which said propeller rotates is inclined with respect to the longitudinal axis of the fuselage.

6. The aircraft according to claim 1 wherein the at least one powerplant comprises a propeller powerplant and a rotor powerplant, the propeller and main helicopter rotor being operatively connected to the propeller and rotor powerplants respectively, said propeller and propeller powerplant being pivotally mounted to adjust an angle at which the transverse plane in which said propeller rotates is inclined with respect to the longitudinal axis of the fuselage.

7. The aircraft according to claim 1 wherein the propeller is adjustable in pitch an is pivotally mounted to adjust an angle at which the transverse plane in which said propeller rotates is inclined with respect to the longitudinal axis of the fuselage.

8. The aircraft according to claim 1 wherein the propeller is adjustable in pitch and the at least one powerplant comprises a propeller powerplant and a rotor powerplant, the propeller and main helicopter rotor being operatively connected to the propeller and rotor powerplants respectively and said propeller and propeller powerplant being pivotally mounted to adjust an angle at which the transverse plane in which said propeller rotates is inclined with respect to the longitudinal axis of the fuselage.

9. The aircraft according to claim 1 further comprising a torque countering device for countering a torque reaction exerted on the fuselage about the axis of the main helicopter rotor caused by driven rotation of said rotor.

10. The aircraft according to claim 9 wherein the torque countering device comprises a tail rotor supported for rotation in generally vertical plane parallel to the longitudinal axis of the fuselage rearward of said fuselage.

11. The aircraft according to claim 1 further comprising a vertical stabilizer supported rearward of the fuselage.

12. The aircraft according to claim 1 further comprising a horizontal stabilizer supported rearward of the fuselage.
